(19) United States
(12) Patent Application Publication
(10) Pub. No.: US 2026/0233729 A1
(43) Pub. Date: Aug. 13, 2026

(54) SYNTHESIZED ODOMETRY

(71) Applicant: GM GLOBAL TECHNOLOGY OPERATIONS LLC, Detroit, MI (US)

(72) Inventors: Matan Yeger, Pardes Hanna-Karkur (IL); Khizar A. Qureshi, Pickering (CA); Mohammadali Shahriari, Markham (CA); Ami Woo, Calgary (CA); Hassan Askari, Thornhill (CA); Nimrod Goldberg, Hafia (IL)

(73) Assignee: GM GLOBAL TECHNOLOGY OPERATIONS LLC, Detroit, MI (US)

(21) Appl. No.: 19/051,568

(22) Filed: Feb. 12, 2025

(51) Int. Cl. B60W 30/06; B60W 30/14; B60W 30/18; B60W 50/00

(52) U.S. Cl. CPC B60W 30/06; B60W 30/143; B60W 30/18063; B60W 50/00; B60W 2050/0008; B60W 2050/0056; B60W 2520/105; B60W 2552/15

(57) ABSTRACT

An odometry system includes multiple detectors and an electronic control unit. The detectors are operational to detect a move event of a vehicle and a stop event of the vehicle. The electronic control unit coupled to the plurality of detectors. The electronic control unit includes an odometry state estimator a feedback loop and a low velocity motion controller. The odometry state estimator is operational to generate an estimated odometry state of the vehicle in response to the move event and the stop event. The feedback loop wraps around the odometry state estimator and is operational to force a zero-velocity constraint in the estimated odometry state to correct inaccuracies in an estimated position of the vehicle. The low velocity motion controller is operational to generate a speed command that controls a longitudinal motion of the vehicle during an automated parking assist movement based on the estimated odometry state.

### INTRODUCTION

The present disclosure relates to a system and a method for synthesized odometry.

Longitudinal velocity estimation from odometry typically suffers from latency during stop-to-move events and move-to stop-events on an order of 1 to 2 seconds. The latency may result in a low velocity maneuvering control to overshoot torque requests on an order of 50%. The torque overshoots result in uncomfortable scenarios for customers during an automated park assist maneuvers. The scenarios occur when conflicts exist between what the odometry reports and what the low velocity maneuvering speed commands.

Accordingly, those skilled in the art continue with research and development efforts in the field of synthesizing odometry with adaptive weighting to mitigate longitudinal torque overshoot during low velocity maneuvering.

### SUMMARY

An odometry system is provided herein. The odometry system includes a plurality of detectors and an electronic control unit. The plurality of detectors are operational to detect a move event of a vehicle and a stop event of the vehicle. The electronic control unit is coupled to the plurality of detectors. The electronic control unit includes an odometry state estimator operational to generate an estimated odometry state of the vehicle in response to the move event and the stop event, a feedback loop around the odometry state estimator and operational to force a zero-velocity constraint in the estimated odometry state to correct inaccuracies in an estimated position of the vehicle, and a low velocity motion controller operational to generate a speed command that controls a longitudinal motion of the vehicle during an automated parking assist movement based on the estimated odometry state.

In one or more embodiments of the odometry system, the feedback loop is further operational to adaptively weigh zero velocity updates, and the odometry state estimator includes an extended Kalman filter operational to utilize the zero velocity updates during the move event.

In one or more embodiments of the odometry system, the odometry state estimator is further operational to detect the stop event using a velocity zero crossing per the extended Kalman filter.

In one or more embodiments of the odometry system, the plurality of detectors includes an axle torque detector operational to measure an axle torque, a brake torque detector operational to measure a brake torque, and a road grade detector operational to measure a gravitational torque applied to the vehicle.

In one or more embodiments of the odometry system, the odometry state estimator is further operational to generate the estimated odometry state of the vehicle in further response to the axle torque, the brake torque and the gravitational torque.

In one or more embodiments of the odometry system, the odometry state estimator is further operational to learn and adapt to a creep torque, and generate the estimated odometry state of the vehicle in further response to the creep torque.

In one or more embodiments of the odometry system, the plurality of detectors includes an inertial measurement unit operational to measure a longitudinal acceleration of the vehicle, and the odometry state estimator is further operational to generate the estimated odometry state of the vehicle in further response to the longitudinal acceleration.

In one or more embodiments of the odometry system, the odometry state estimator is further operational to arbitrate between the plurality of detectors, and generate a vehicle motion indication and a vehicle velocity based on the move event and the stop event as arbitrated.

In one or more embodiments of the odometry system, the odometry state estimator is further operational to generate the estimated odometry state of the vehicle in further response to the vehicle motion indication and the vehicle velocity.

A method for synthesized odometry is provided herein. The method includes detecting with a plurality of detectors a move event of a vehicle and a stop event of the vehicle, generating with an odometry state estimator an estimated odometry state of the vehicle in response to the move event and the stop event, forcing with a feedback loop a zero-velocity constraint in the estimated odometry state to correct inaccuracies in an estimated position of the vehicle, and generating with a low velocity motion controller a speed command that controls a longitudinal motion of the vehicle during an automated parking assist movement based on the estimated odometry state.

In one or more embodiments, the method includes adaptively weighing zero velocity updates with a feedback loop around the odometry state estimator, and utilizing the zero velocity updates during the move event with an extended Kalman filter of the odometry state estimator.

In one or more embodiments, the method includes detecting the stop event with a velocity zero crossing per the extended Kalman filter.

In one or more embodiments, the method includes measuring an axle torque with an axle torque detector of the plurality of detectors, measuring a brake torque with a brake torque detector of the plurality of detectors, and measuring a gravitational torque applied to the vehicle with a road grade detector of the plurality of detectors.

In one or more embodiments of the method, the generating of the estimated odometry state of the vehicle is in further response to the axle torque, the brake torque and the gravitational torque.

In one or more embodiments, the method includes learning and adapting to a creep torque, where the generating of the estimated odometry state of the vehicle in further response to the creep torque.

In one or more embodiments, the method includes measuring a longitudinal acceleration of the vehicle with an inertial measurement unit of the plurality of detectors, where the generating of the estimated odometry state of the vehicle is in further response to the longitudinal acceleration.

In one or more embodiments, the method includes arbitrating between the plurality of detectors, and generating a vehicle motion indication and a vehicle velocity based on the move event and the stop event as arbitrated.

In one or more embodiments of the method, the generating of the estimated odometry state of the vehicle is in further response to the vehicle motion indication and the vehicle velocity.

A vehicle is provided herein. The vehicle includes a plurality of detectors, an electronic control unit, and a drive system. The plurality of detectors are operational to detect a move event of the vehicle and a stop event of the vehicle. The electronic control unit is coupled to the plurality of detectors. The electronic control unit includes an odometry state estimator operational to generate an estimated odometry state of the vehicle in response to the move event and the stop event, a feedback loop operational to force a zero-velocity constraint in the estimated odometry state to correct inaccuracies in an estimated position of the vehicle, and a low velocity motion controller operational to generate a speed command that controls a longitudinal motion of the vehicle during an automated parking assist movement based on the estimated odometry state. The drive system is operational to move the vehicle in response to the speed command.

In one or more embodiments of the vehicle, the feedback loop is further operational to adaptively weigh zero velocity updates, and the odometry state estimator includes an extended Kalman filter operational to utilize the zero velocity updates during the move event.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a context of a system accordance with one or more exemplary embodiments.

FIG. 2 is a schematic diagram of detectors and an electronic control unit in accordance with one or more exemplary embodiments.

FIG. 3 is a graph of vehicle speed estimations in accordance with one or more exemplary embodiments.

FIG. 4 is a graph of a longitudinal velocity estimation in accordance with one or more exemplary embodiments.

FIG. 5 is a graph of vehicle velocity estimations in accordance with one or more exemplary embodiments.

FIG. 6 is a flow diagram of method for movement state monitoring in accordance with one or more exemplary embodiments.

FIG. 7 is a graph of an auto parking assist movement in accordance with one or more exemplary embodiments.

FIG. 8 is a graph of a stop detection in accordance with one or more exemplary embodiments.

### DETAILED DESCRIPTION

Embodiments of the disclosure provide a system and/or method for synthesizing odometry with adaptive weighting to mitigate longitudinal torque overshoot during low velocity maneuvering. Closed loop filtering around an odometry velocity estimation behavior generally reduces latency of reporting zero velocity events in addition to orthogonal sensor information. Reduction in the latency may be achieved by developing multiple (e.g., two) closed loop behaviors, zero crossing (stop event) and adaptive weighting (move event), along with sensor information from other vehicle detectors (e.g., an inertial measurement unit, wheel speed detectors, and axle torque detectors). Data from an inertial measurement unit (IMU) (e.g., longitudinal acceleration) and total torque data, after accounting for gravity, is used to reduce the latency of move events. Looking at closed loop extended Kalman filter (EKF) behavior when the velocity crosses zero, without a gear change, indicates a stop event. Total torque, adjusted for gravity, may be used for early detection of the stop events as well.

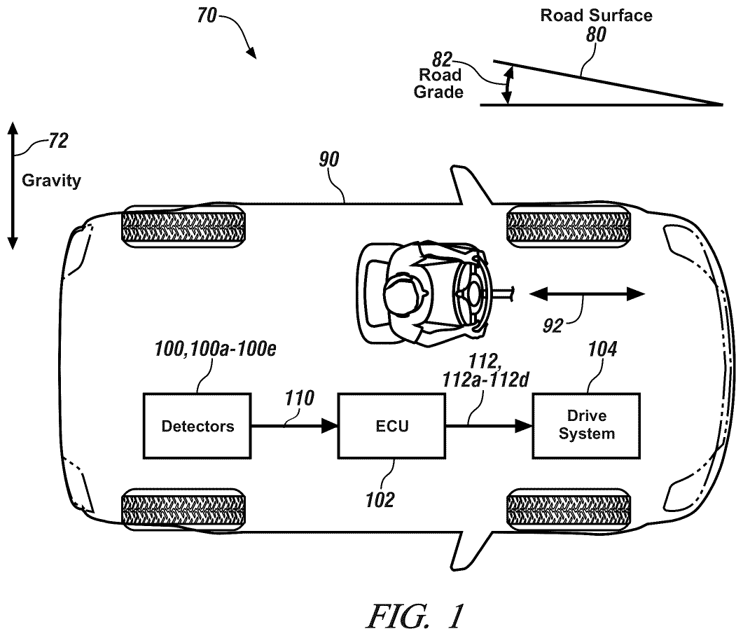

Referring to FIG. 1, a schematic plan diagram illustrating a context of a system 70 is shown in accordance with one or more exemplary embodiments. The system 70 may include gravity 72, a road surface 80, and a vehicle 90. The vehicle 90 generally includes multiple detectors 100, an electronic control unit 102 (ECU) and a drive system 104. A longitudinal direction 92 of the vehicle 90 is generally oriented from front-to-back of the vehicle 90. The vehicle 90 resides on and move along the road surface 80.

The road surface 80 may have a road grade 82. The road grade 82 and the gravity 72 generally apply a force on the vehicle 90 down the road grade 82.

The vehicle 90 implements a gas-powered vehicle, an electric vehicle, a hybrid vehicle, or a plug-in hybrid vehicle. In various embodiments, the vehicle 90 may include, but is not limited to, a passenger vehicle, a truck, an autonomous vehicle, a motorcycle, a boat, and/or an aircraft. Other types of vehicles 90 may be implemented to meet the design criteria of a particular application.

The detectors 100 implement multiple detectors within the vehicle 90 that are operational to detect motion of the vehicle 90. The detectors 100 may include, but are not limited to, an internal reference unit (IMU) detector 100a, one or more axle torque detectors 100b, one or more brake torque detectors 100c, a road grade detector 100d, and wheel encoder 100e. The detectors 100 may present sensor information (or data) 110 to the ECU 102.

The ECU 102 implements multiple digital computation circuits. The digital computation circuits may transfer data with one another across a communications bus. The digital computation circuits may be implemented in hardware, software executing on hardware, or a combination of both. The ECU 102 may receive the sensor information 110 from the detectors 100 and present drive commands 112 to the drive system 104.

In various embodiments, the electronic control unit 102 generally includes at least one microcontroller. The at least one microcontroller may include one or more processors, each of which may be embodied as a separate processor, an application specific integrated circuit (ASIC), a field programmable gate array (FPGA), or a dedicated electronic control unit. The at least one microcontroller may be an electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components and communicate instructions to the other electronic components.

The drive system 104 implements a semi-autonomous drive system. The drive system 104 is operational to control a steering, acceleration, braking, and gear shifting of the vehicle 90 based on drive commands 112 received from the ECU 102. The drive commands 112 may include a steering command 112a, an acceleration command 112b, a braking command 112c and a gear selection command 112d.

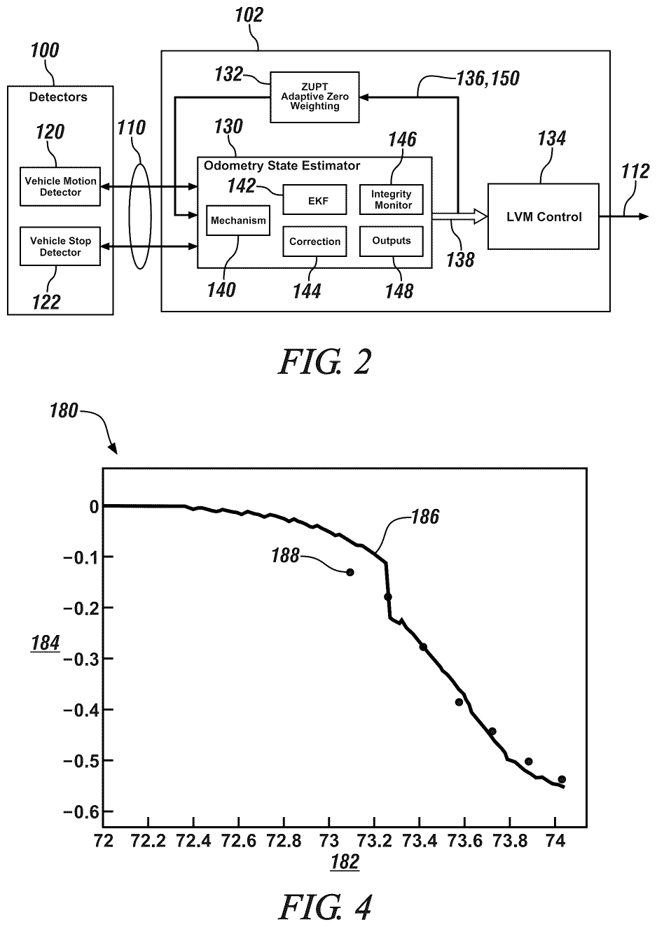

Referring to FIG. 2, a schematic diagram of an example implementation of the detectors 100 and the ECU 102 is shown in accordance with one or more exemplary embodiments. The detectors 100 generally include vehicle motion detectors 120 and vehicle stop detectors 122. The ECU 102 may include an odometry state estimator 130, a feedback loop filter 132, and a low velocity maneuvering (LVM) controller 134. A feedback loop 136 is formed through the feedback loop filter 132 from an output side of the odometry state estimator 130 back to an input side odometry state estimator 130.

The detectors 100 may generate and present the sensor information 110 to the odometry state estimator 130. The odometry state estimator 130 generates and presents estimated odometry states 138 of the vehicle 90 to the LVM controller 134. Velocity updates 150 in the estimated odometry states 138 are routed along the feedback loop 136 through the feedback loop filter 132 and back to the odometry state estimator 130. The LVM controller 134 generates and presents the drive commands 112 based on the estimated odometry states 138.

The odometry state estimator 130 includes a mechanism block 140, an extended Kalman filter (EKF) 142, a correction block (or corrector) 144, and integrity monitor 146 and an output block 148.

The feedback loop filter 132 implements a zero velocity update (ZUPT) adaptive zero weighting filter. The ZUPT filter is dynamically adjusted proportional to a residual velocity determined by the EKF 142.

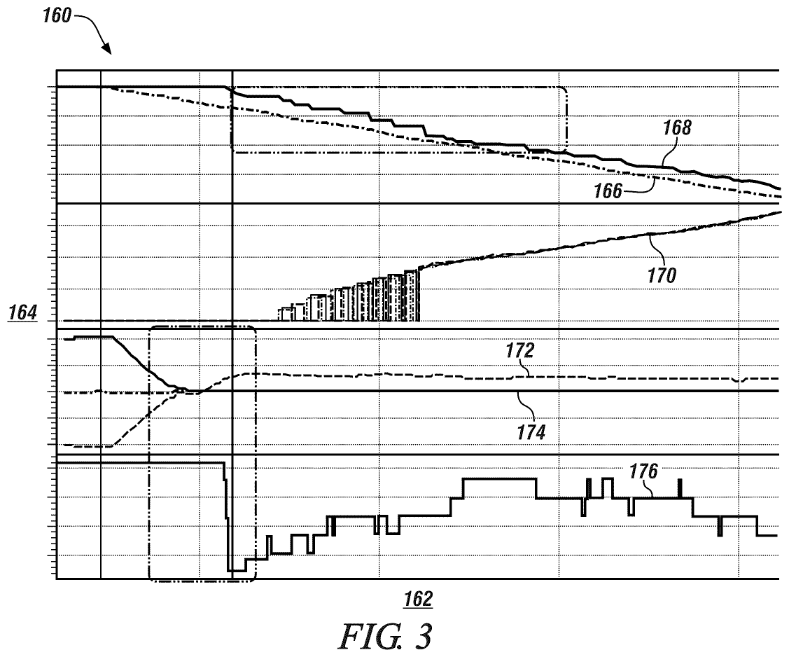

For vehicle motion detection, an approach similar to what is used for moving-to-stop events (or declarations) may be applied to reduce latency for stop-to-move events (or declarations). The EKF 142 forces a zero-velocity constraint, to prevent inaccuracies in position estimations, when the vehicle 90 is deemed to be stopped. From recent vehicle data (as shown in FIGS. 3-5) even though the LVM controller 134 is commanding a speed, the zero constraint is forcing the speed to be zero. The EKF 142 updates every few hundreds of milliseconds and hence may produce a “zigzag” behavior in velocity. In this case the vehicle 90 performs an auto park leg in reverse, and the velocity goes negative and then to zero. This is when the zero constraint kicks in. Monitoring this behavior, along with other sensor information, we can reduce the stop to move latency as well.

Referring to FIG. 3, a graph of example vehicle speed estimations is shown in accordance with one or more exemplary embodiments. The graph 160 has an X-axis 162 in units of time, and a Y-axis 164 in units of velocity.

A curve 166 illustrates a velocity command from longitudinal control of the vehicle 90. A curve 168 is an estimated velocity determined by the EKF 142. A curve 170 is a raw longitudinal speeds from wheel speed sensors. A curve 172 is a total axle torque. A curve 174 is an axle torque and a brake torque. A curve 176 is a longitudinal acceleration.

Referring to FIG. 4, a graph of an example longitudinal velocity estimation is shown in accordance with one or more exemplary embodiments. The graph 180 has an X-axis 182 in units of time, and a Y-axis 184 in units of velocity.

A curve 186 illustrated an estimated longitudinal velocity. Points 188 illustrate wheel speed sensor data from a right rear wheel.

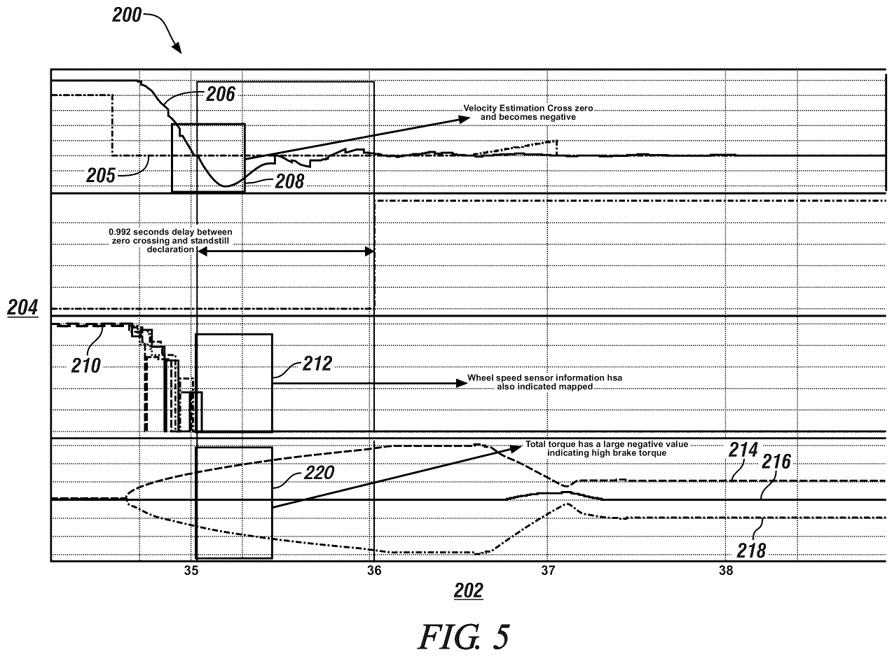

Referring to FIG. 5, a graph of an example vehicle velocity estimations is shown in accordance with one or more exemplary embodiments. The graph 200 has an X-axis 202 in units of time, and a Y-axis 204 in units of velocity.

For vehicle stopped detection, the longitudinal velocity estimate, from the EKF 142, may be observed to cross zero (e.g., went negative) prior to the vehicle 90 coming to a full stop. A curve 205 illustrates the LVM velocity command. A curve 206 illustrates the EKF velocity estimate. As the LVM velocity command drops to zero (in window 208), the vehicle 90 eventually come to a stop. While the velocity dropping below zero (negative) at the same time wheel speed sensor information reports zero velocity and total torque is at a large threshold, due to high brake torque. Using this information together can overcome individual shortcomings for reducing latency in move to stop events.

In window 208, the estimated velocity crosses zero and becomes negative. A curve 210 illustrates wheel speed sensor information. In window 212, the wheel speed sensor information indicates that the vehicle 90 has stopped. A curve 214 is the brake torque. A curve 216 is the axle torque. A curve 218 is a total axle torque. In window 220, the total torque has a large negative value that indicates a high braking torque.

Returning to FIG. 2, dynamic weighting in the feedback loop filter 132 implements a dynamic adjustment proportional to the EKF velocity residual. The velocity residual is a byproduct of the EKF 142, at the update stage, estimating a non-zero velocity but the zero-velocity constraint still being applied. The weight of the update is changed per equation (1) as follows:

$${σ}_{zupt} = α * \vert 0 - {\hat{v}}_{x} \vert \qquad Eq . ( 1 )$$

Where σ_{zupt} is a standard deviation of zero velocity update, \hat{v}ₓ is an estimated velocity of the EKF 142, and α is given by equation (2) as follows:

$$α = f ( {τ}_{total} , {a}_{x} , {n}_{xx} ) \qquad Eq . ( 2 )$$

Where τₜₒₜₐₗ is a total torque, aₓ is a longitudinal acceleration of the vehicle 90 from the IMU detector 100a, and nₓₓ is an edge count from the wheel encoders 100e.

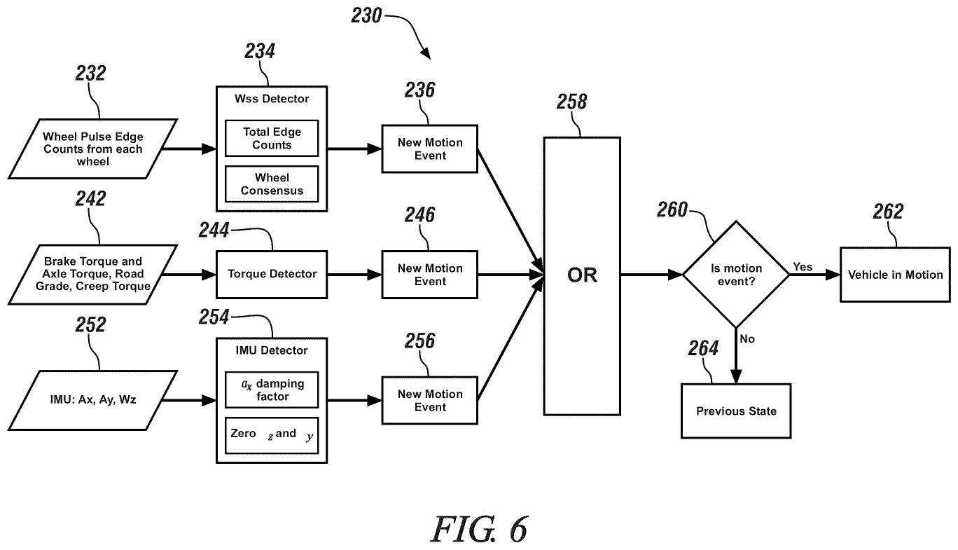

Referring to FIG. 6, a flow diagram of an example method for movement state monitoring is shown in accordance with one or more exemplary embodiments. The method 230 generally incudes steps 232 to 264, as illustrated. The sequence of steps is shown as a representative example. Other step orders may be implemented to meet the criteria of a particular application.

In the step 232, wheel pulse edge counts from each wheel may be monitored. The wheel speed sensor detector may provide a total edge count and wheel consensus in the step 234. A new motion event may be declared in the step 236 based on the wheel speed sensor information.

In the step 242, the brake torque, the axle torque, the road grade and the creep torque may be monitored. The torque detector may provide the total torque in the step 244. A new motion event may be declared in the step 246 based on the total torque information.

In the step 252, longitudinal acceleration (Ax), lateral acceleration (Ay), and z-axis rotational speed (Wz) may be monitored. The IMU detector 100a may provide longitudinal damping factor for the longitudinal acceleration Ax, and zeroing of the lateral acceleration Ay and the rotational speed Wz in the step 254. A new motion event may be declared in the step 256 based on the IMU information.

In the step 258, a Boolean OR of the new motion events from the step 236, 246 and 256 is determined. If one or more motion events is detected in the step 260, the vehicle 90 is declared in motion in the step 262. Otherwise, the vehicle 90 is declared stopped in the step 264.

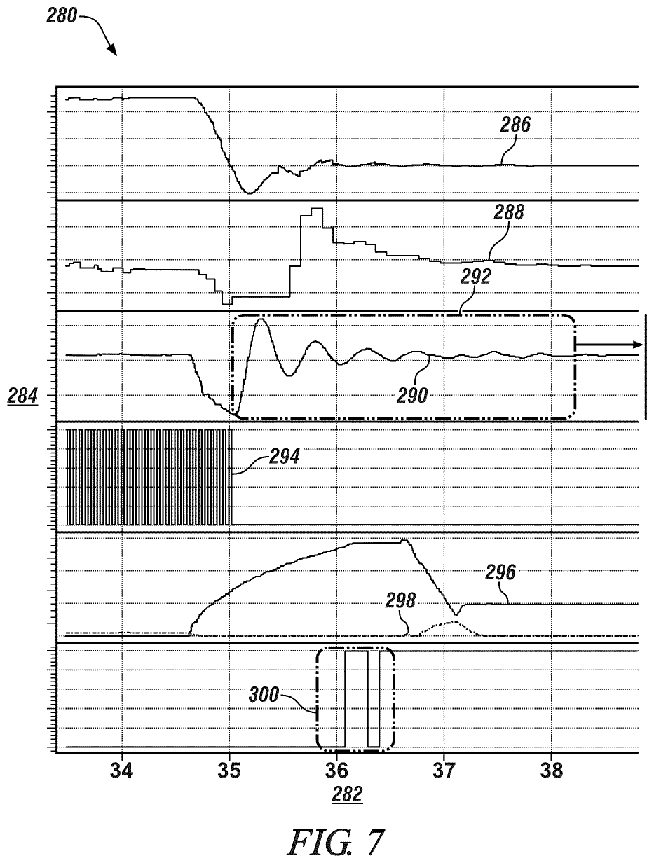

Referring to FIG. 7, a graph of an example auto parking assist movement is shown in accordance with one or more exemplary embodiments. The graph 280 includes an X-axis 282 in units of time and a Y-axis 284 in units of velocity.

As the IMU detector 100a is mounted on a spring mass, the IMU detector 100a faces oscillations when the wheels lock to a stop. The oscillations, in the forward/backward direction show up as longitudinal accelerations. Therefore, the longitudinal acceleration and zero crossing detections may reduce latency for scenarios like auto park that involves back-to-back move-to-stop motions and stop-to-move motions.

The graph 280 illustrates how the problem of using longitudinal acceleration for stop/move detection is solved by overcoming the oscillatory behavior of accelerometer. A curve 286 shows the velocity estimate from EKF 142. A curve 288 shows a vehicle pitch angle. Damped oscillations of a curve 290 may be seen in window 292. A curve 294 illustrates the wheel speed sensor pulses. A curve 296 illustrates a brake torque and a curve 298 illustrates a total axle torque. Window 300 shows the vehicle stopped indication. To solve the oscillation problem, a frequency and an amplitude of the curve 290 are observed to ensure the curve 290 is solely damping with no behavior change.

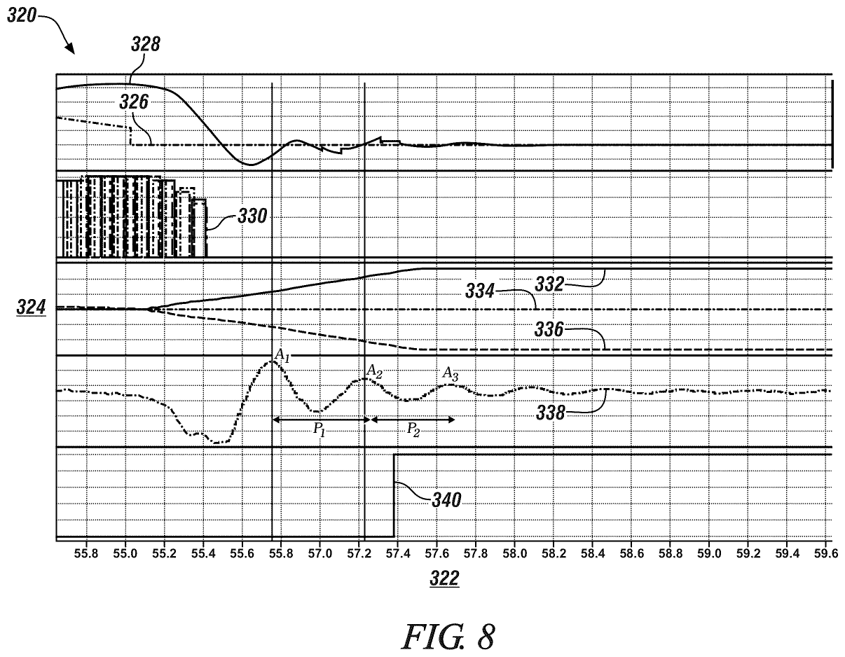

Referring to FIG. 8, a graph of an example stop detection is shown in accordance with one or more exemplary embodiments. The graph 320 includes an X-axis 322 in units of time and a Y-axis 324 in units of velocity.

A curve 326 illustrates a longitudinal control velocity command. A curve 328 is the EKF estimated velocity. A curve 330 is the raw speed from wheel speed sensors. A curve 332 is the brake torque. A curve 334 is the axle torque. A curve 336 is the total axle torque. A curve 338 illustrates a longitudinal acceleration from the accelerometer and a curve 340 is the vehicle standstill indication. Peaks A₁, A₂, and A₃ are consecutive damped peaks of the longitudinal acceleration. Periods P₁ and P₂ are time periods between each peak A₁, A₂, and A₃.

Once the vehicle 90 is stopped (as shown in the data in FIG. 8), using historic data, a time factor and an amplitude factor may be calculated per equations (3), (4) and (5) as follows:

$$x ( {n}_{1} ) = {A}_{1} , x ( {n}_{2} ) = {A}_{2} , x ( {n}_{3} ) = {A}_{3} \qquad Eq . ( 3 )$$

$${Δ t}_{1} = {T}_{s} ( {n}_{2} - {n}_{1} ) \qquad Eq . ( 4 )$$

$${Δ t}_{2} = {T}_{s} ( {n}_{3} - {n}_{2} ) \qquad Eq . ( 5 )$$

Where x(n) is the index at which amplitude occurs, T_{S} is the sample time at which data comes in, and Δt is the time difference (period) between two amplitudes per equations (6) and (7) as follows:

$${A}_{favg} = \frac{{A}_{{f}_{1}} + {A}_{{f}_{2}}}{2} \qquad Eq . ( 6 )$$

Where A_{f} is the amplitude factor.

$${T}_{favg} = \frac{{Δ t}_{1} + {Δ t}_{2}}{2} \qquad Eq . ( 7 )$$

Where T_{f} is the time factor.

If |A_{f}|<A_{favg}+ϵ_{A} AND |T_{f}|<T_{favg}+ϵ_{T}, then aₓ is damping. If both an amplitude factor and a time factor are within a tolerance, represented by ϵ, the oscillation observed in longitudinal velocity is declared damping and behavior is consistent solely with spring-mass vibration and vehicle 90 has stopped. The factors are learned under the same condition as creep torque given as follows, where the signal is buffered over a time T from which amplitude factor and time factors are learned. For the following cases, a decision may be made using two amplitude peaks per equation (8) as follows:

$${\int }_{t - T}^{t} {v}_{x} ( t ) dt \tilde{=} 0 \qquad Eq . ( 8 )$$

For internal combustion engine (ICE) type vehicles 90, solely implementing a technique to use total torque may not work. A torque at standstill is approximately 434 Newton-meters with a zero brake command. The actual torque varies from vehicle to vehicle and so the technique may learn the standstill torque for a particular vehicle and dynamically adjust the threshold. To overcome the issue, an internal creep torque learn methodology is fed in to offset a particular threshold for total torque. The learn methodology may be expressed by if

$${\int }_{t - T}^{t} {v}_{x} ( t ) dt \tilde{=} 0 ,$$

$$then {τ}_{creep} = τ ( t ) .$$

Where vₓ(t) is velocity at time t, T is the time suitable to confidently declare the vehicle is stopped without other sensor information, τ(t) is the axel torque at this time and τ_{creep} may be the creep torque. The τ_{creep} value may be used as an offset to the threshold of total torque for stop-to-move or move-to-stop declarations.

Similarly, an effect of the road grade 82 may be accounted using the total torque for vehicle motion event decision. The equation (9) shows a complete total torque estimation to declare if vehicle 90 is stopped:

$${τ}_{stopped} = ( {τ}_{axle} + {τ}_{creep} ) - {τ}_{brake} - {m}_{veh} * ℊ * z * sin ( θ ) \qquad Eq . ( 9 )$$

Embodiments of the disclosure generally improve a customer experience while using parking maneuvers without additional hardware. The system/method generally adaptively weigh zero velocity updates used by the EKF during move events. Early detection of move-to-stop events may be achieved using the EKF velocity zero crossing. Axle torque, brake torque and road grade are considered to detect stop events and/or the move events. Various embodiments may learn and adapt to creep torque for use in vehicle motion events to provide a common solution for internal combustion engine vehicles and electric vehicles with various modes of operation such as one pedal driving, auto hold, and the like. Longitudinal acceleration detected by an IMU may be used for early detection of move events. Furthermore, arbitration between various stop/move detectors may be used to achieve improved performance for vehicle motion indication and vehicle velocity.

Embodiments of the disclosure generally provide an odometry system that includes multiple detectors and an electronic control unit. The detectors are operational to detect a move event of a vehicle and a stop event of the vehicle. The electronic control unit is coupled to the detectors. The electronic control unit includes an odometry state estimator operational to generate an estimated odometry state of the vehicle in response to the move event and the stop event, a feedback loop around the odometry state estimator and operational to force a zero-velocity constraint in the estimated odometry state to correct inaccuracies in an estimated position of the vehicle, and a low velocity motion controller operational to generate a speed command that controls a longitudinal motion of the vehicle during an automated parking assist movement based on the estimated odometry state.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. An odometry system comprising:
a plurality of detectors operational to detect a move event of a vehicle and a stop event of the vehicle; and
an electronic control unit coupled to the plurality of detectors, wherein the electronic control unit includes:
an odometry state estimator operational to generate an estimated odometry state of the vehicle in response to the move event and the stop event;
a feedback loop around the odometry state estimator and operational to force a zero-velocity constraint in the estimated odometry state to correct inaccuracies in an estimated position of the vehicle; and
a low velocity motion controller operational to generate a speed command that controls a longitudinal motion of the vehicle during an automated parking assist movement based on the estimated odometry state.

2. The odometry system according to claim 1, wherein:
the feedback loop is further operational to adaptively weigh zero velocity updates; and
the odometry state estimator includes an extended Kalman filter operational to utilize the zero velocity updates during the move event.

3. The odometry system according to claim 2, wherein:
the odometry state estimator is further operational to detect the stop event using a velocity zero crossing per the extended Kalman filter.

4. The odometry system according to claim 1, wherein the plurality of detectors includes:
an axle torque detector operational to measure an axle torque;
a brake torque detector operational to measure a brake torque; and
a road grade detector operational to measure a gravitational torque applied to the vehicle.

5. The odometry system according to claim 4, wherein the odometry state estimator is further operational to:
generate the estimated odometry state of the vehicle in further response to the axle torque, the brake torque and the gravitational torque.

6. The odometry system according to claim 5, wherein the odometry state estimator is further operational to:
learn and adapt to a creep torque; and
generate the estimated odometry state of the vehicle in further response to the creep torque.

7. The odometry system according to claim 1, wherein:
the plurality of detectors includes an inertial measurement unit operational to measure a longitudinal acceleration of the vehicle; and
the odometry state estimator is further operational to generate the estimated odometry state of the vehicle in further response to the longitudinal acceleration.

8. The odometry system according to claim 1, wherein the odometry state estimator is further operational to:
arbitrate between the plurality of detectors; and
generate a vehicle motion indication and a vehicle velocity based on the move event and the stop event as arbitrated.

9. The odometry system according to claim 8, wherein the odometry state estimator is further operational to:
generate the estimated odometry state of the vehicle in further response to the vehicle motion indication and the vehicle velocity.

10. A method for synthesized odometry comprising:
detecting with a plurality of detectors a move event of a vehicle and a stop event of the vehicle;
generating with an odometry state estimator an estimated odometry state of the vehicle in response to the move event and the stop event;
forcing with a feedback loop a zero-velocity constraint in the estimated odometry state to correct inaccuracies in an estimated position of the vehicle; and
generating with a low velocity motion controller a speed command that controls a longitudinal motion of the vehicle during an automated parking assist movement based on the estimated odometry state.

11. The method according to claim 10, further comprising:
adaptively weighing zero velocity updates with a feedback loop around the odometry state estimator; and
utilizing the zero velocity updates during the move event with an extended Kalman filter of the odometry state estimator.

12. The method according to claim 11, further comprising:
detecting the stop event with a velocity zero crossing per the extended Kalman filter.

13. The method according to claim 10, further comprising:
measuring an axle torque with an axle torque detector of the plurality of detectors;
measuring a brake torque with a brake torque detector of the plurality of detectors; and
measuring a gravitational torque applied to the vehicle with a road grade detector of the plurality of detectors.

14. The method according to claim 13, wherein:
the generating of the estimated odometry state of the vehicle is in further response to the axle torque, the brake torque and the gravitational torque.

15. The method according to claim 14, further comprising:
learning and adapting to a creep torque, wherein
the generating of the estimated odometry state of the vehicle in further response to the creep torque.

16. The method according to claim 10, further comprising:
measuring a longitudinal acceleration of the vehicle with an inertial measurement unit of the plurality of detectors, wherein
the generating of the estimated odometry state of the vehicle is in further response to the longitudinal acceleration.

17. The method according to claim 10, further comprising:
arbitrating between the plurality of detectors; and
generating a vehicle motion indication and a vehicle velocity based on the move event and the stop event as arbitrated.

18. The method according to claim 17, wherein:
the generating of the estimated odometry state of the vehicle is in further response to the vehicle motion indication and the vehicle velocity.

19. A vehicle comprising:
a plurality of detectors operational to detect a move event of the vehicle and a stop event of the vehicle;
an electronic control unit coupled to the plurality of detectors, wherein the electronic control unit includes:
an odometry state estimator operational to generate an estimated odometry state of the vehicle in response to the move event and the stop event;
a feedback loop operational to force a zero-velocity constraint in the estimated odometry state to correct inaccuracies in an estimated position of the vehicle; and
a low velocity motion controller operational to generate a speed command that controls a longitudinal motion of the vehicle during an automated parking assist movement based on the estimated odometry state; and
a drive system operational to move the vehicle in response to the speed command.

20. The vehicle according to claim 19, wherein:
the feedback loop is further operational to adaptively weigh zero velocity updates; and
the odometry state estimator includes an extended Kalman filter operational to utilize the zero velocity updates during the move event.
